(19) United States
(12) Patent Application Publication
(10) Pub. No.: US 2013/0028618 A1
(43) Pub. Date: Jan. 31, 2013

(54) WASTE TONER TRANSPORT SYSTEM, WASTE TONER TRANSPORT METHOD, AND IMAGE FORMING APPARATUS

(71) Applicants: Hiroki ANDO, Kanagawa (JP); Toshie NAKAMOTO, Kanagawa (JP)

(72) Inventors: Hiroki ANDO, Kanagawa (JP); Toshie NAKAMOTO, Kanagawa (JP)

(73) Assignee: FUJI XEROX CO., LTD., Tokyo (JP)

(21) Appl. No.: 13/401,506

(22) Filed: Feb. 21, 2012

(30) Foreign Application Priority Data
Jul. 29, 2011 (JP) 2011-166679

(51) Int. Cl. G03G 21/00; G03G 21/12

(52) U.S. Cl. 399/35; 399/358

(57) ABSTRACT

A waste toner transport system includes a transport unit that has a transport space through which toner removed from a surface of an image bearing member is transported, where the transport space contains a transport member that rotates and transports the toner. The waste toner transport system further includes a container that contains the toner transported by the transport member, and a controller that controls rotation of the transport member so that an amount of toner transported by the transport member per unit time is decreased if an amount of the toner contained in the container reaches a threshold value.

### CROSS-REFERENCE TO RELATED APPLICATIONS

This application is based on and claims priority under 35 USC 119 from Japanese Patent Application No. 2011-166679 filed Jul. 29, 2011.

### BACKGROUND

### Technical Field

The present invention relates to a waste toner transport system, a waste toner transport method, and an image forming apparatus.

### SUMMARY

According to an aspect of the invention, there is provided a waste toner transport system including a transport unit that has a transport space through which toner removed from a surface of an image bearing member is transported, where the transport space contains a transport member that rotates and transports the toner, a container that collects the toner transported by the transport member and contains the collected toner, and a controller that controls rotation of the transport member so that an amount of toner transported by the transport member per unit time is decreased if an amount of the toner contained in the container reaches a threshold value.

### BRIEF DESCRIPTION OF THE DRAWINGS

An exemplary embodiment of the present invention will be described in detail based on the following figures, wherein:

FIG. 1 is a block diagram of an exemplary configuration of an image forming apparatus according to an exemplary embodiment of the invention;

FIG. 2 is a schematic illustration of an exemplary configuration of an image forming unit;

FIG. 3 is a cross-sectional view of a transport path;

FIG. 4 is a cross-sectional view of a waste toner container;

FIG. 5 is a flowchart of a process for detecting that the waster toner container is full;

FIG. 6 illustrates the capacity of the waste toner container;

FIG. 7 illustrates a control table used for controlling a rotation speed;

FIG. 8 is a timing diagram for controlling a rotation time;

FIG. 9 illustrates a relationship between the number of printed sheets and the amount of toner collected into the waste toner container;

FIG. 10 illustrates a comparison of a reserve capacity according to a related art and a reserve capacity according to the exemplary embodiment;

FIG. 11 is a schematic illustration of an image forming unit according to a modification;

FIG. 12 is a cross-sectional view of a transport path according to a modification; and

FIG. 13 is a cross-sectional view of a waste toner container according to a modification.

### DETAILED DESCRIPTION

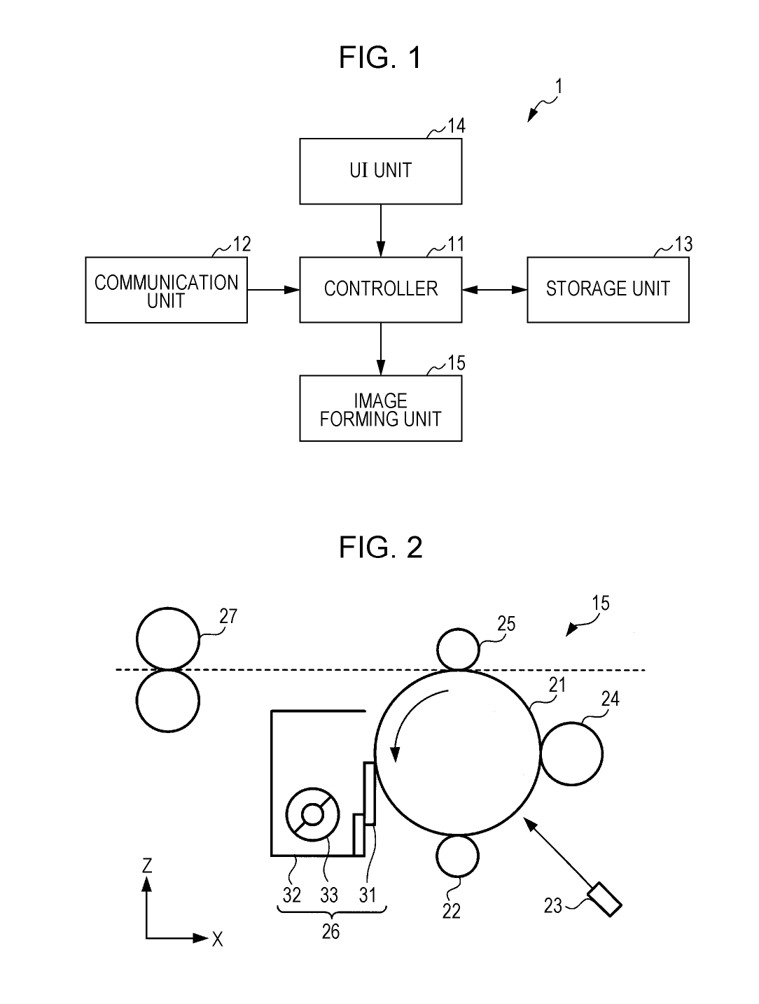

FIG. 1 is a block diagram of an exemplary configuration of an image forming apparatus 1 according to an exemplary embodiment of the invention. The image forming apparatus 1 is formed from an electrophotographic printer. The image forming apparatus 1 includes a controller 11, a communication unit 12, a storage unit 13, a user interface (UI) unit 14, and an image forming unit 15. The controller 11 includes a central processing unit (CPU) and a memory. The CPU executes a program stored in the memory and controls units of the image forming apparatus 1. The communication unit 12 serves as a communication interface connected to a communication line. For example, if a computer apparatus transmits image data to the image forming apparatus 1, the image forming apparatus 1 receives the image data using the communication unit 12. The storage unit 13 is formed from a storage device, such as a hard disk. The storage unit 13 stores a variety of types of data. The UI unit 14 includes, for example, a touch screen and keys. The UI unit 14 is used for operating the image forming apparatus 1. The image forming unit 15 forms an image on a sheet of paper in accordance with the image data.

FIG. 2 is a schematic illustration of an exemplary configuration of the image forming unit 15. The image forming unit 15 includes a photoconductor drum 21. The photoconductor drum 21 (an example of an image bearing member) has a cylindrical shape. The photoconductor drum 21 has a photoconductive film on the surface thereof. The photoconductor drum 21 is rotated about the axis thereof by a drum motor (not illustrated). A charging unit 22, an exposure apparatus 23, a developing device 24, a transfer roller 25, and a cleaning unit 26 are disposed around the photoconductor drum 21. The charging unit 22 (an example of a charging unit) uniformly charges the surface of the photoconductor drum 21. The exposure unit 23 (an example of an exposure unit) performs an exposure operation on the charged photoconductor drum 21 in accordance with image data and forms an electrostatic latent image. The developing device 24 (an example of a developing device) develops the electrostatic latent image formed on the photoconductor drum 21 with toner. The transfer roller 25 (an example of a transfer unit) transfers the image developed by the developing device 24 onto a sheet of paper (an example of a medium). A fixing unit 27 applies heat and pressure onto the images on the sheet and fixes the images on the sheet of paper. The sheet that has passed through the fixing unit 27 is ejected from the image forming apparatus 1.

The cleaning unit 26 is disposed downstream of the transfer roller 25. The cleaning unit 26 removes residual toner remaining on a surface of the photoconductor drum 21. The cleaning unit 26 includes a cleaning member 31, a housing 32, and a transport member 33. The cleaning member 31 (an example of a removing unit) has, for example, a blade shape. In such a case, by urging the cleaning member 31 onto the surface of the photoconductor drum 21, the cleaning unit 26 removes toner from the surface of the photoconductor drum 21. The toner removed by the cleaning member 31 falls down into the housing 32 (an example of a transport unit).

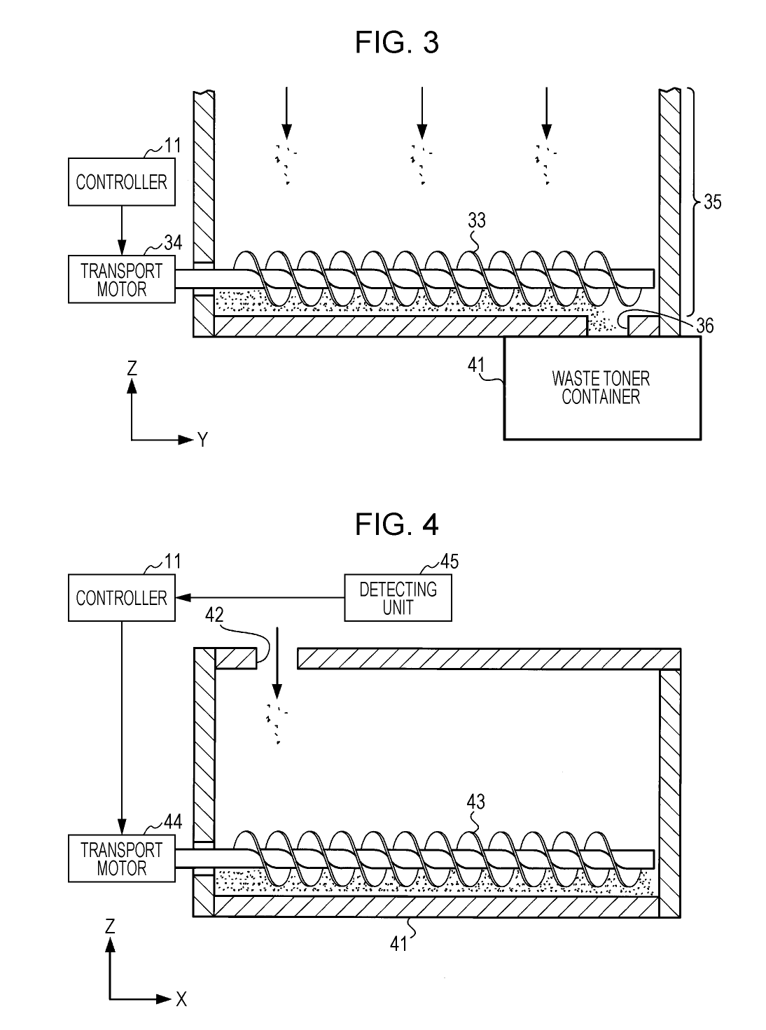

The housing 32 includes a transport path 35 (an example of a transport space) through which the toner removed away from the surface of the photoconductor drum 21 is transported. FIG. 3 is a cross-sectional view of the transport path 35. The transport member 33 is disposed in the transport path 35. The transport member 33 has a shaft and a full spiral screw formed around the shaft. One end of the shaft is connected to a transport motor 34. The transport member 33 is rotated by the transport motor 34. With rotation of the transport member 33, the toner in the housing 32 is transported in a direction indicated by an arrow Y illustrated in FIG. 3. The transport path 35 has an opening 36 at the bottom thereof. The toner transported by the transport member 33 falls down into a waste toner container 41 (an example of a container) through the opening 36.

FIG. 4 is a cross-sectional view of the waste toner container 41. The waste toner container 41 has an opening 42 formed on the upper surface thereof so as to face the opening 36. The toner that falls down through the opening 36 is collected and contained in the waste toner container 41 through the opening 42. The waste toner container 41 includes a transport member 43 and a detecting unit 45. The transport member 43 has a shaft and a full spiral screw formed around the shaft. One end of the shaft is connected to a transport motor 44. The transport member 43 is rotated by the transport motor 44. With rotation of the transport member 43, the toner in the waste toner container 41 is transported in a direction indicated by an arrow X illustrated in FIG. 4. In this way, the toner distribution in the waste toner container 41 is made uniform.

The detecting unit 45 detects whether the amount of toner contained in the waste toner container 41 reaches a threshold value K1. If the amount of toner contained in the waste toner container 41 reaches a threshold value K1, the detecting unit 45 outputs a detection signal. The detecting unit 45 performs the detection using, for example, an optical sensor. The optical sensor includes a light emitting unit that emits light and a light receiving unit that receives the light. The light emitting unit and the light receiving unit are disposed so as to face each other with the waste toner container 41 therebetween. Before the amount of toner contained in the waste toner container 41 reaches the threshold value K1, the light emitted from the light emitting unit is received by the light receiving unit through the inside of the waste toner container 41. If the amount of toner contained in the waste toner container 41 reaches the threshold value K1, the toner contained in the waste toner container 41 enters between the light emitting unit and the light receiving unit. At that time, the light emitted from the light emitting unit is blocked by the toner and, therefore, the amount of light received by the light receiving unit varies. In this way, it is detected that the amount of toner contained in the waste toner container 41 reaches the threshold value K1. As described above, according to the present exemplary embodiment, since the detecting unit 45 detects whether the amount of toner contained in the detecting unit 45 reaches the threshold value K1, it is accurately detected that the amount of toner contained in the waste toner container 41 reaches the threshold value K1.

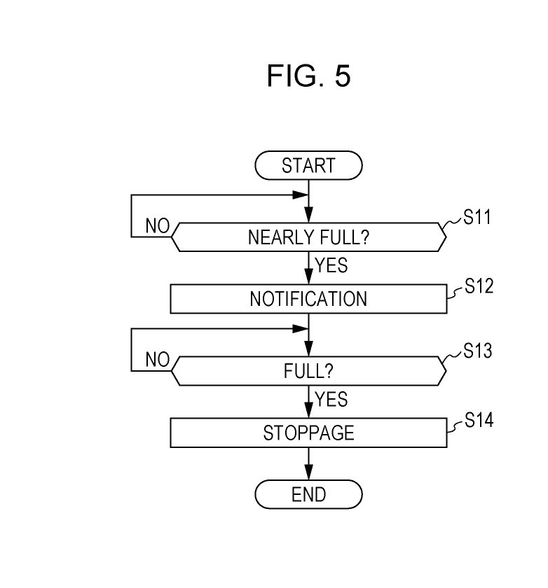

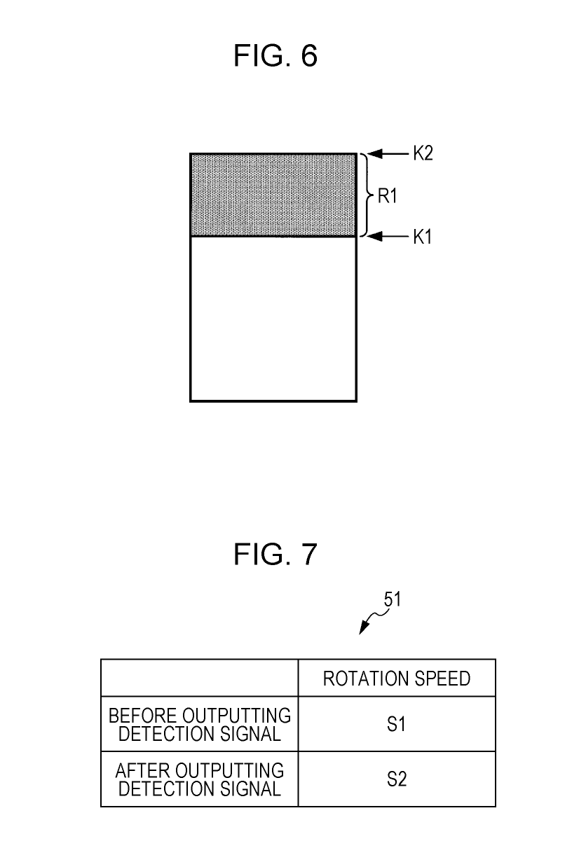

The controller 11 detects whether the waste toner container 41 is full. FIG. 5 is a flowchart of the detection process performed by the controller 11. The controller 11 determines whether the waste toner container 41 is nearly full (step S11). FIG. 6 illustrates the capacity of the waste toner container 41. As more images are formed, more toner is accumulated in the waste toner container 41. If the amount of toner in the waste toner container 41 is smaller than the threshold value K1, the detecting unit 45 does not output a detection signal. In such a case, the controller 11 determines that the waste toner container 41 is not nearly full (NO in step S11). However, if the amount of toner in the waste toner container 41 reaches the threshold value K1, the detecting unit 45 outputs a detection signal. In such a case, the controller 11 determines that the waste toner container 41 is nearly full (YES in step S11).

If the waste toner container 41 is nearly full, the controller 11 notifies the user of information indicating that the waste toner container 41 is nearly full (step S12). For example, the controller 11 instructs the UI unit 14 to display a message indicating that the waste toner container 41 is nearly full. The user is aware of the notification indicating that the waste toner container 41 is nearly full. Thereafter, the user prepares a new waste toner container that is to be mounted in place of the waste toner container 41. As illustrated in FIG. 6, the waste toner container 41 has a reserve capacity R1 so that the image forming apparatus 1 can be used for a certain period of time (e.g., a week) after the waste toner container 41 becomes nearly full. The reserve capacity R1 is determined in accordance with, for example, a period of time necessary for the user to obtain a new waste toner container and the number of sheets to be printed for that period. For example, when a week is necessary for the user to obtain a new waste toner container and if 800 sheets are printed for a week, the reserve capacity R1 is determined so that the waste toner container can contain the amount of toner collected after 800 sheets are printed.

In addition, if the waste toner container 41 is nearly full, the controller 11 determines whether the waste toner container 41 is full on the basis of information regarding the use conditions of the image forming apparatus 1 (step S13). Examples of the use condition include the number of printed sheets and the number of pixels. In this case, if the waste toner container 41 is nearly full, the controller 11 starts measuring the number of printed sheets and the number of pixels. More specifically, the controller 11 counts the number of sheets on which images are formed and stores, as the number of printed sheets, the counted number of sheets in a memory. In addition, the controller 11 counts the number of pixels in a region in which an image is formed using the image data supplied to the exposure apparatus 23 and stores the counted number of pixels in the memory. If each of the number of printed sheets and the number of pixels stored in the memory does not reach a threshold value, the controller 11 determines that the waste toner container 41 is not full (NO in step S13). However, if at least one of the number of printed sheets and the number of pixels stored in the memory reaches the threshold value (YES in step S13), it is highly likely that the amount of toner in the waste toner container 41 reaches an upper limit K2 illustrated in FIG. 6. In such a case, the controller 11 determines that the waste toner container 41 is full (YES in step S13).

If the amount of toner contained in the waste toner container 41 exceeds the upper limit K2, the toner spills out of the waste toner container 41. In order to prevent the toner from spilling out, if the controller 11 (an example of a stopping unit) determines that the waste toner container 41 is full, the controller 11 stops the operation performed by the image forming unit 15 until the user replaces the waste toner container 41 (step S14). That is, if the amount of toner collected into the waste toner container 41 reaches the upper limit K2, the controller 11 stops the operation performed by the image forming unit 15.

In addition, if the detecting unit 45 outputs the detection signal, the controller 11 (an example of a controller) controls the transport motor 34 so that the amount of toner transported by the transport member 33 per unit time is reduced. For example, in order to reduce the amount of toner transported per unit time, the following two techniques can be employed: a technique for decreasing the rotation speed of the transport member 33 and a technique for decreasing the period of time during which the transport member 33 is rotated.

FIG. 7 illustrates a control table 51 used for controlling the rotation speed. The control table 51 is prestored in the storage unit 13. The control table 51 includes information regarding a normal rotation speed S1 and a rotation speed S2 that is lower than the rotation speed S1. Until the detecting unit 45 outputs a detection signal, the controller 11 controls the transport motor 34 so that the transport member 33 is rotated at the rotation speed S1 specified in the control table 51. In contrast, when the waste toner container 41 is nearly full and if the detecting unit 45 outputs a detection signal, the controller 11 controls the transport motor 34 so that the transport member 33 is rotated at the rotation speed S2 specified in the control table 51. In such a case, the number of rotation of the transport member 33 per unit time is decreased. Accordingly, the amount of toner transported by the transport member 33 per unit time is decreased.

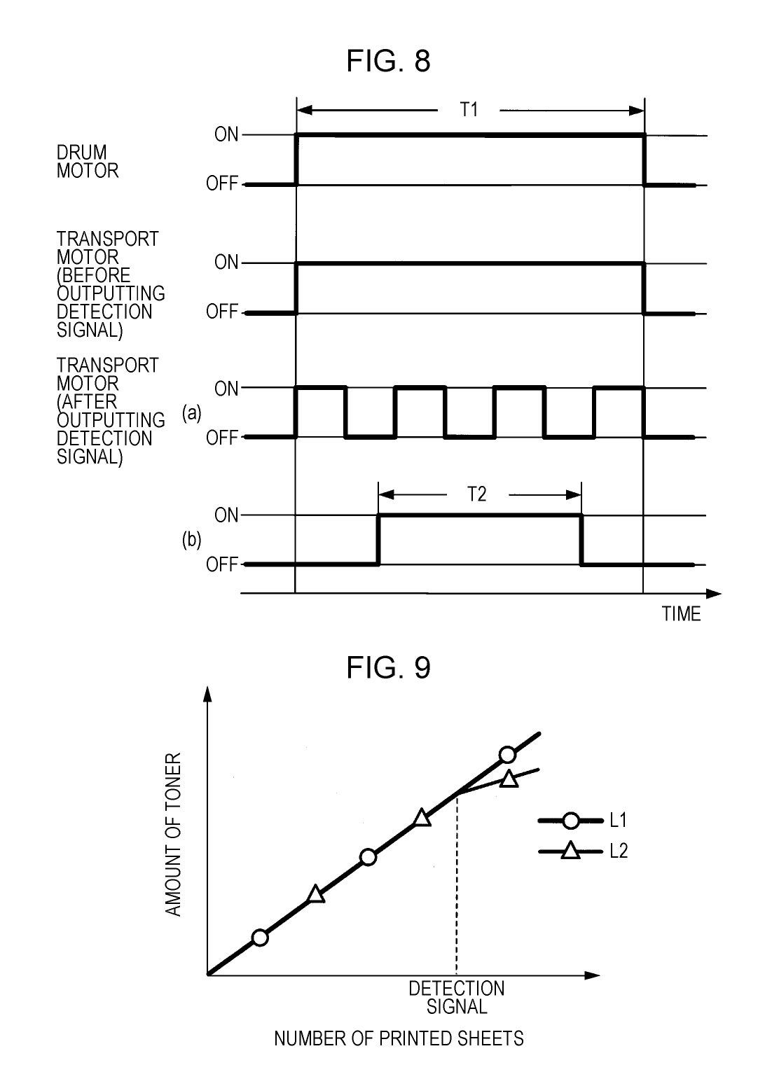

FIG. 8 is a timing diagram for controlling the rotation time. Until the detecting unit 45 outputs a detection signal, the controller 11 operates the transport motor 34 in order to rotate the transport member 33 during a period of time T1 during which the drum motor operates. In contrast, when the waste toner container 41 is nearly full and if the detecting unit 45 outputs a detection signal, the controller 11 repeatedly turns on and off the transport motor 34 in order to stop and resume the rotation of the transport member 33 during the period of time T1 as illustrated in the case (a) of FIG. 8, for example. In such a case, the transport member 33 is intermittently rotated and, therefore, the rotation time of the transport member 33 is reduced. Thus, the amount of toner transported by the transport member 33 per unit time is reduced. Alternatively, as illustrated in the case (b) of FIG. 8, the controller 11 operates the transport motor 34 during a period of time T2 that is less than the period of time T1. In such a case, the transport member 33 is rotated only for the period of time T2 and, therefore, the amount of toner transported by the transport member 33 per unit time is reduced. According to such a technique, the amount of toner transported by the transport member 33 per unit time can be reduced without controlling the rotation speed of the transport member 33.

If the amount of toner transported by the transport member 33 per unit time is reduced in this manner, the toner is collected in the transport path 35 and, therefore, the amount of toner transported to the waste toner container 41 is reduced. Accordingly, even when the numbers of printed sheets are the same, the amount of toner collected into the waste toner container 41 is reduced. FIG. 9 illustrates a relationship between the number of printed sheets and the amount of toner collected into the waste toner container 41. A line L1 illustrated in FIG. 9 indicates the amount of toner collected into the waste toner container 41 when the amount of toner transported by the transport member 33 per unit time is not reduced, as in the related art. A line L2 illustrated in FIG. 9 indicates the amount of toner collected into the waste toner container 41 when the amount of toner transported by the transport member 33 per unit time is reduced, as in the present exemplary embodiment. Until the detection signal is output, the amounts of toner collected into the waste toner container 41 are the same in both cases. However, after the detection signal is output, the amount of toner collected into the waste toner container 41 in the case where, as in the present exemplary embodiment, the amount of toner transported by the transport member 33 per unit time is reduced is smaller than in the case where, as in the related art, the amount of toner transported by the transport member 33 per unit time is not reduced.

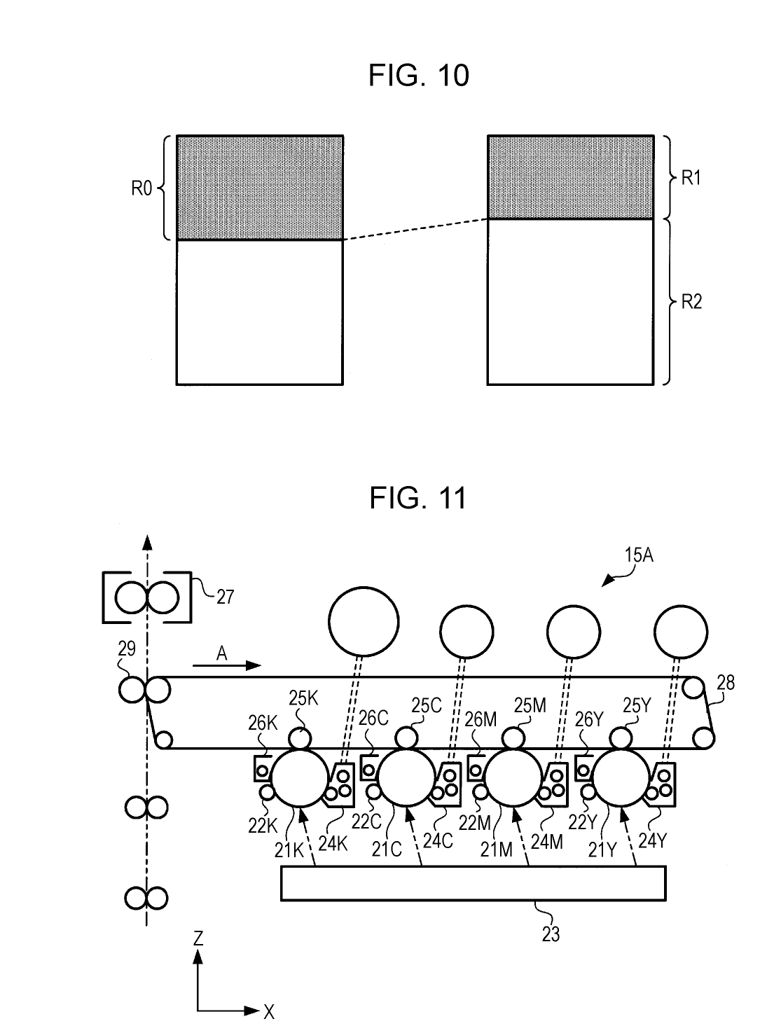

As described above, if the amount of toner collected into the waste toner container 41 is reduced after a detection signal is output, the reserve capacity provided for the waste toner container 41 can be small. FIG. 10 illustrates a comparison of a reserve capacity R0 according to the related art and the reserve capacity R1 according to the present exemplary embodiment. In the related art, if, for example, it is configured so that 800 images can be formed after the waste toner container 41 becomes nearly full, the reserve capacity R0 is necessary. However, according to the present exemplary embodiment, as illustrated in FIG. 9, after the detection signal is output, the amount of toner collected into the waste toner container 41 can be reduced even when the numbers of the printed sheets are the same. In such a case, even when it is configured so that 800 images can be formed after the waste toner container 41 becomes nearly full, the reserve capacity R1 that is smaller than the reserve capacity R0 is sufficient. If the reserve capacity R1 is reduced, a capacity R2 for storing toner collected until the waste toner container 41 becomes nearly full is increased. Alternatively, if the capacity R2 remains unchanged, the size of the waste toner container 41 can be reduced.

In addition, the amount of toner transported into the waste toner container 41 varies with the amount of toner in the transport path 35. For example, if the amount of toner in the transport path 35 is large, the amount of toner transported into the waste toner container 41 is also large. According to the present exemplary embodiment, in order to prevent the toner from spilling out of the waste toner container 41, the reserve capacity R1 of the waste toner container 41 is determined so that the amount of toner in the transport path 35 is maximized. However, if, as in the related art, the amount of toner transported by the transport member 33 per unit time is not decreased, the toner in the transport path 35 is immediately transported into the waste toner container 41. Accordingly, the amount of toner in the transport path 35 is small. Therefore, the amount of toner actually collected into the waste toner container 41 is smaller than the reserve capacity for the waste toner container 41. In contrast, according to the present exemplary embodiment, after the detection signal is output, the amount of toner transported by the transport member 33 per unit time is reduced, and the amount of toner in the transport path 35 is increased. Accordingly, an error between the reserve capacity R1 provided for the waste toner container 41 and the amount of toner transported into the waste toner container 41 can be reduced.

The present invention is not limited to the above-described exemplary embodiment. The above-described exemplary embodiment may be modified in the following manner. In addition, any of the following modifications may be combined together.

### MODIFICATION 1

The image forming apparatus 1 may be a printer that forms a color image. FIG. 11 is a schematic illustration of an image forming unit 15A according to the present modification. The image forming unit 15A includes the photoconductor drum 21, the charging unit 22, the developing device 24, the transfer roller 25 (hereinafter referred to as a “first transfer roller 25”), and the cleaning unit 26 for each of yellow color, magenta color, cyan color, and a black color. Note that in the following description, the reference symbol of a component related to generation of a yellow image has a suffix “Y”, the reference symbol of a component related to generation of a magenta image has a suffix “M”, the reference symbol of a component related to generation of a cyan image has a suffix “C”, and the reference symbol of a component related to generation of a black image has a suffix “K”.

In addition, the image forming unit 15A includes an intermediate transfer belt 28 and a second transfer roller 29. First transfer rollers 25Y, 25M, 25C, and 25K transfer images formed on photoconductor drums 21Y, 21M, 21C, and 21K onto the intermediate transfer belt 28, respectively. The intermediate transfer belt 28 revolves in a direction indicated by an arrow A illustrated in FIG. 11 and transports the images transferred by the first transfer rollers 25Y, 25M, 25C, and 25K to the second transfer roller 29. The second transfer roller 29 transfers the images transported by the intermediate transfer belt 28 onto a sheet of paper.

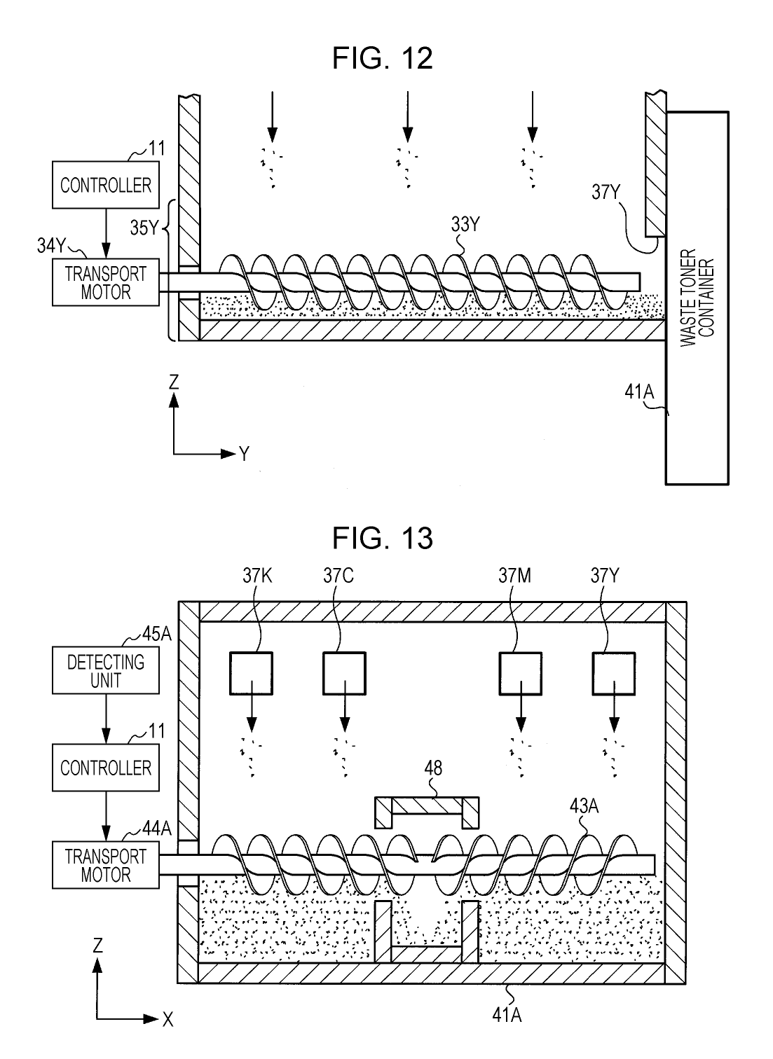

Cleaning units 26Y, 26M, 26C, and 26K includes transport paths 35Y, 35M, 35C, and 35K, respectively. FIG. 12 is a cross-sectional view of the transport path 35Y. The transport path 35Y has a configuration that is substantially the same as the transport path 35 illustrated in FIG. 3. Unlike the transport path 35, the transport path 35Y has an opening 37Y instead of the opening 36. The opening 37Y is formed at one end of the transport path 35Y. The toner transported by a transport member 33Y falls into a waste toner container 41A (an example of a waste toner unit) through the opening 37Y. Note that each of the transport paths 35M, 35C, and 35K has a configuration that is substantially the same as the transport path 35Y.

FIG. 13 is a cross-sectional view of a waste toner container 41A. The toner that falls down through the openings 37Y, 37M, 37C, and 37K is contained in the waste toner container 41A. The waste toner container 41A includes a transport member 43A, a detecting unit 45A, and a detection chamber 48. The transport member 43A has a shaft and a full spiral screw formed around the shaft. One end of the shaft is connected to a transport motor 44A. The transport member 43A is rotated by the transport motor 44A. With rotation of the transport member 43A, the toner in the waste toner container 41A is transported to the central point of the waste toner container 41A. The detection chamber 48 is configured so that if the amount of toner contained in the waste toner container 41A exceeds a predetermined value, the toner enters the detection chamber 48. Like the above-described detecting unit 45, the detecting unit 45A detects that the amount of toner contained in the detection chamber 48 reaches the threshold value K1 and outputs a detection signal. Even in the present modification, if the amount of toner contained in the waste toner container 41A reaches the threshold value K1, the amount of toner transported into the waste toner container 41 is decreased.

### MODIFICATION 2

It should be noted that a technique for reducing the amount of toner transported per unit time is not limited to the technique according to the present exemplary embodiment. For example, in controlling the rotation speed of the transport member 33, the controller 11 may gradually reduce the rotation speed of the transport member 33 as the number of sheets having images formed thereon increases after the detecting unit 45 outputs a detection signal. Alternatively, when repeatedly stopping and resuming the rotation of the transport member 33 during the period of time T1 as illustrated in the case (a) of FIG. 8, the controller 11 may change the ratio of a rotation time to a stoppage time or the intervals between rotation times. Still alternatively, when rotating the transport member 33 during the period of time T2 as illustrated in the case (b) of FIG. 8, the controller 11 may reduce the period of time T2 as the number of sheets having images formed thereon increases after the detecting unit 45 outputs a detection signal. Yet still alternatively, the controller 11 may employ the above-described technique for reducing the rotation speed of the transport member 33 and the above-described technique for reducing the rotation time of the transport member 33 at the same time. In such a case, the amount of toner transported by the transport member 33 per unit time can be reduced to less than in the case in which these methods are not simultaneously employed.

### MODIFICATION 3

While the above-described exemplary embodiment has been described with reference to the detecting unit 45 that detects whether the amount of toner in the waste toner container 41 reaches the threshold value K1 by using an optical sensor, it can be detected whether the amount of toner in the waste toner container 41 reaches the threshold value K1 by using a technique without using an optical sensor. For example, the detecting unit 45 may detect whether the amount of toner in the waste toner container 41 reaches the threshold value K1 by using a magnetic sensor. In such a case, the magnetic sensor measures the intensity of a magnetic field inside the waste toner container 41 and outputs a detection signal if the measured intensity reaches a value set in accordance with the threshold value K1.

### MODIFICATION 4

The location at which the waste toner container 41 is disposed is not limited to the location illustrated in FIG. 3. For example, the waste toner container 41 may be disposed so as to be parallel to the transport path 35. In such a case, the transport member 33 delivers the toner inside of the transport path 35 toward the waste toner container 41.

### MODIFICATION 5

While the above-described exemplary embodiment has been described with reference to the number of printed sheets and the number of pixels for determining whether the waste toner container 41 becomes full, only one of the number of printed sheets and the number of pixels may be used. In addition, the information regarding such a use condition is not limited to the number of printed sheets and the number of pixels. For example, the number of rotation of the photoconductor drum 21 or the number of rotation of the transport member 33 can be used.

### MODIFICATION 6

The transport member 33 may have a screw other than the full spiral screw. For example, the screw of the transport member 33 may have a plate-like blade. In such a case, plural blades are provided on the shaft of the transport member 33 at predetermined intervals. Similarly, the transport member 43 may have a screw other than the full spiral screw.

### MODIFICATION 7

The shape of the cleaning member 31 is not limited to a blade shape. For example, the cleaning member 31 may be formed from a brush. In such a case, the cleaning unit 26 removes toner from the surface of the photoconductor drum 21 by rotating the brush.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A waste toner transport system comprising:
a transport unit that has a transport space through which toner removed from a surface of an image bearing member is transported, the transport space containing a transport member that rotates and transports the toner;
a container that contains the toner transported by the transport member; and
a controller that controls rotation of the transport member so that an amount of toner transported by the transport member per unit time is decreased if an amount of the toner contained in the container reaches a threshold value.

2. The waste toner transport system according to claim 1, wherein if the amount of toner contained in the container reaches the threshold value, the controller reduces a rotation speed per unit time of the transport member.

3. The waste toner transport system according to claim 1, wherein if the amount of toner contained in the container reaches the threshold value, the controller reduces a rotation time of the transport member.

4. The waste toner transport system according to claim 1, further comprising:
a detecting unit that detects that the amount of toner contained in the container reaches the threshold value and outputs a detection signal;
wherein the controller controls the rotation after the detecting unit outputs the detection signal.

5. An image forming apparatus comprising:
an image forming unit that includes an image bearing member, a charging unit that charges the image bearing member, an exposure unit that performs an exposure operation on the image bearing member charged by the charging unit in accordance with image data and forms an electrostatic latent image, a developing device that develops the electrostatic latent image formed by the exposure unit with toner, a transfer unit that transfers the image developed by the developing device onto a medium, a fixing unit that fixes the image transferred by the transfer unit onto the medium, a removing unit that removes the toner from a surface of the image bearing member, and the waste toner transport system according to claim 1; and
a stopping unit that stops an operation of the image forming unit if an amount of toner contained in the container reaches an upper limit.

6. A waste toner transport method comprising:
transporting toner removed from a surface of an image bearing member through a transport space using a transport member that is disposed in the transport space and that rotates;
storing the transported toner in a container; and
controlling rotation of the transport member so that an amount of transported toner per unit time is decreased if an amount of the toner contained in the container reaches a threshold value.
